(19) United States
(12) Patent Application Publication
(10) Pub. No.: US 2006/0091197 A1
(43) Pub. Date: May 4, 2006

(54) Computer implemented teaching aid

(75) Inventor: Amy Catherine Branton, London (GB)

Correspondence Address: PEARNE & GORDON LLP, 1801 EAST 9TH STREET, SUITE 1200, CLEVELAND, OH, 44114-3108, US

(73) Assignee: Skybluepink Interaction Design Ltd., London (GB)

(21) Appl. No.: 11/017,376

(22) Filed: Dec. 20, 2004

(30) Foreign Application Priority Data
Nov. 4, 2004 (GB) 0424472.9

(51) Int. Cl. G06F 17/00

(52) U.S. Cl. 235/375; 235/435

(57) ABSTRACT

A computerised teaching apparatus that comprises: a plurality of items, for example cards (9), each comprising a computer-readable medium, preferably a RFID tag, arranged to store data that corresponds to a physical attribute of the card (9). The apparatus further comprises a reader (7) that is arranged to generate input signals, each input signal representing the data stored on the computer-readable medium of one card (9). The apparatus also comprises a computer (1) programmed to receive the plurality of input signals sequentially and arranged to generate, in response to a detection of a stored predetermined combination of input signals, an output signal representative of that combination.

The present invention relates to a computerised teaching apparatus, and to a computerised teaching method for use in a computerised teaching apparatus, that is particularly, though not exclusively, suited for teaching primary school children a foreign language.

Computerised teaching aids are used widely to assist teaching of many different subjects and students of many different academic levels and capabilities. Most computerised teaching aids are simply computer programs operated on a standard computer having a screen, a keyboard and a mouse. However, this arrangement does not readily support pre-school and primary school teaching, or the teaching of the disabled. In these situations, the intended operator may not be capable of operating a standard keyboard or mouse. These standard arrangements limit an operator's ability to operate a computer. Additional hardware can be used in place of a keyboard and mouse to provide the tangible interface for a user to operate the computer when programmed with the bespoke teaching software. Often this interface (both software and hardware) is adapted to make it easy for the user to use, by providing an interactive play experience.

One type of known interface is known as POGO, as disclosed in the Internet web page www.design.phillips.com/smartconnections/pogo/index.html on 24 Aug. 2004, uses individual stand alone cards, in the form of discs, comprising a unique computer readable radio frequency identification (RFID) tag. Each card is a physical pointer to a virtual “story world” element. These elements include sounds, images and videos. Each card is also attached to a physical item e.g. a drawing, a model, or another toy. The apparatus also comprises a bucket, which is electrically connected to a computer. The bucket functions as a card reader. Activating a card by, for example, placing it in a bucket, causes the computer to display a story element on a screen, or a loudspeaker to emit a sound. The cards can be associated with specific physical items. For an example, an item is scanned to provide a scanned image that is stored on a computer readable memory in the computer. Each scanned image can be physically associated with a card. However, each card can only be associated with one scanned image, and therefore one physical item.

This POGO system is designed to be a computer-implemented storytelling application. Therefore, the computer is arranged to display images and broadcast sounds in response to activation by the RFD tags comprised in the cards. The system therefore has a structure to support the association of a card with a bespoke image data file and a preset sound and image data file. Also, even though the item associated with each card can be varied, the physical attributes of each card remains the same. All cards have exactly the same physical appearance.

GB-A-2376192 discloses another computerised teaching aid that has a plurality of elements, each element having a RFID tag. This document also discloses a seat or holder having a radio frequency transponder, for reading the RFID tags. The seat is electrically connected to a computer. When an element is placed in the seat, an associated signal is sent to the computer. Each element is associated with a different graphical animation for display on the computer screen and a characteristic soundtrack for broadcast by a loudspeaker. On receipt of a signal from the seat, the computer is arranged to display and broadcast the animation and soundtrack. The animation can be controlled by replacing the element in the seat with another of the elements. However, this only achieves the control of the animation. Each element has only two capabilities: the initiation of an animation and soundtrack and control of animations initiated by a number of other elements.

The present invention provides apparatus, and a method of operation of an apparatus, that enhances the control of a computer application by a simple tangible operating interface. Application of this method and apparatus in a computerised teaching aid enhances and increases the quantity of information that can be taught to students through interactive teaching techniques. This method and apparatus is suited for teaching, for example, a foreign language to pre-school children, as the children can operate the computerised teaching apparatus, by way of selecting an item or card that has physical attributes that correspond to the displayed image or broadcast sound.

In a first aspect of the invention there is a computerised teaching apparatus, the apparatus comprising a plurality of items each comprising: a computer-readable medium arranged to store data that corresponds to a physical attribute of the item; a reader arranged to generate input signals, each input signal representing the data stored on the computer-readable medium of one item; and a computer programmed to receive the plurality of input signals sequentially and arranged to generate, in response to a detection of a stored predetermined combination of input signals, an output signal representative of that combination.

Advantageously, the invention enables an operator to control a complicated programme when run on a computer using a simple operator interface.

Preferably the computer-readable medium comprises an RFID tag, which provides a link to the data stored in the computer. Advantageously, the data can be easily and readily read from the computer readable medium in each item.

Preferably, the physical attribute of any particular item is one of a number of categories, comprising the shape of, the colour of, or the patterning on, that item. Advantageously, the physical features of each item recorded as data on the computer readable medium in an item are physical features of the item that a student would readily recognise. Said predetermined combination may correspond to physical attributes in the same category. Advantageously, the physical features of various items lie in different categories that a student readily recognises and thereby the apparatus readily supports a student's play patterns.

The patterning on an item may be in relief and/or may be provided as a substantially two-dimensional image on the surface of the item.

Preferably, said predetermined combination relates to two items associated with different shapes, the computer being programmed to generate an output signal corresponding to an object in response to detection of that combination. Advantageously, by having items in different categories and by selecting a combination of items having different features in the same category, for example different types of shape, a child can exercise a high degree of control over their learning.

Alternatively said predetermined combination corresponds to physical attributes in different categories. Advantageously, having items in different categories and by selecting a combination of items having features in different categories, for example shape and colour, a child can exercise a high degree of control over their learning.

Apparatus may comprise a device to display visually the output signal. Preferably the computer is programmed to transmit the input signal sequentially to the device to visually display an image, each image being related to the physical attribute of the item represented by the input signal. Advantageously, a child would readily relate to and interact with the visual displayed output and input signals.

Apparatus may comprise a device to broadcast audibly the output signal. Preferably the computer is programmed to transmit the input signals sequentially to the device to broadcast audibly a series of sounds, each sound being related to the physical attribute of the item represented by the input signal. Advantageously, a child would readily relate and interact with the audibly generated output and input signals.

The computer may be programmed to generate a termination signal, the termination signal being generated on detection by the computer of not more than ten of said input signals that do not correspond to a predetermined combination. Preferably the number of input signals detected by the computer before generation of the termination signal is not more than seven, preferably six or even more preferably five.

The predetermined combination can be a predetermined sequence. Advantageously, by using a predetermined sequence rather than a predetermined combination of input signals the number of possible output signals is increased.

The items can be substantially rigid, two-dimensional cards and the reader is a card reader. Advantageously, this is a simple reader to use and implement. It is also simple for the student to operate.

In a second aspect of the invention, there is a computerised teaching method for use in a computerised teaching apparatus, wherein each one of a plurality of items comprises a computer readable medium arranged to store data that corresponds to a physical attribute of the item, the method comprising the steps of: (1) generating input signals, each input signal comprising the said data read from the computer-readable medium of one of the items; (2) sequentially receiving the input signals; and (3) in response to the detection of a predetermined combination of input signals, generating an output signal representative of that combination.

In the method the output signal can comprise a visual signal that is displayed on the screen. In the method the output signal can also comprise an audio signal that is broadcast.

Preferably the method comprises the step of sequentially transmitting each input signal to a device to broadcast a representation of the physical attribute of the item represented by each input signal.

The method can comprise the step of generating a termination signal on detection of not more than ten of said input signals that do not correspond to the predetermined combination. Preferably the number of input signals detected before generation of the termination signal is not more than seven, more preferably six, or even more preferably not more than five.

The predetermined combination can be a predetermined sequence of input signals.

The physical attribute of any particular item may be one of a number of categories comprising the shape of, the colour of, or the patterning on, that item and said predetermined combination corresponds to physical attributes in the same category. Preferably the predetermined combination includes two items having different shapes, the output signal corresponding to an object being generated in response to the detection of that combination.

In the alternative, the physical attribute of any particular item can be one of a number of categories comprising the shape of, the colour of, or the patterning on, that item and said predetermined combination corresponds to physical attributes in different categories.

In a third aspect of the invention there is a computerised teaching method for a computerised teaching apparatus, wherein each one of a plurality of items comprises a computer-readable medium arranged to store data that corresponds to a physical attribute of the item, the method comprising the said steps of: (1) generating input signals, each input signal comprising data read from the computer-readable medium of one of the items; (2) sequentially receiving the input signals; (3) in response to the detection of a predetermined combination of the input signals, generating an output signal representative of that combination; (4) transmitting the output signal simultaneously to a visual display for visually displaying a predetermined image and to an audio device for broadcasting a predetermined sound in a first language and in a second language, the image and sound being associated with the predetermined combination. Advantageously, the apparatus, when connected to a computer, provides a simple operational interface that supports a student's play patterns and interaction, with various physical artefacts and enables the child to learn a foreign language to a greater degree of complexity than using known teaching aids.

In the context of the present invention, each item advantageously is a card, which is preferably substantially rigid and two-dimensional. In a preferred form, the items are rectilinear cards.

Embodiments of a computerised teaching apparatus constructed in accordance with the invention, and a computerised teaching method, will now be described, by way of example only, with reference to the accompanying drawings, in which:

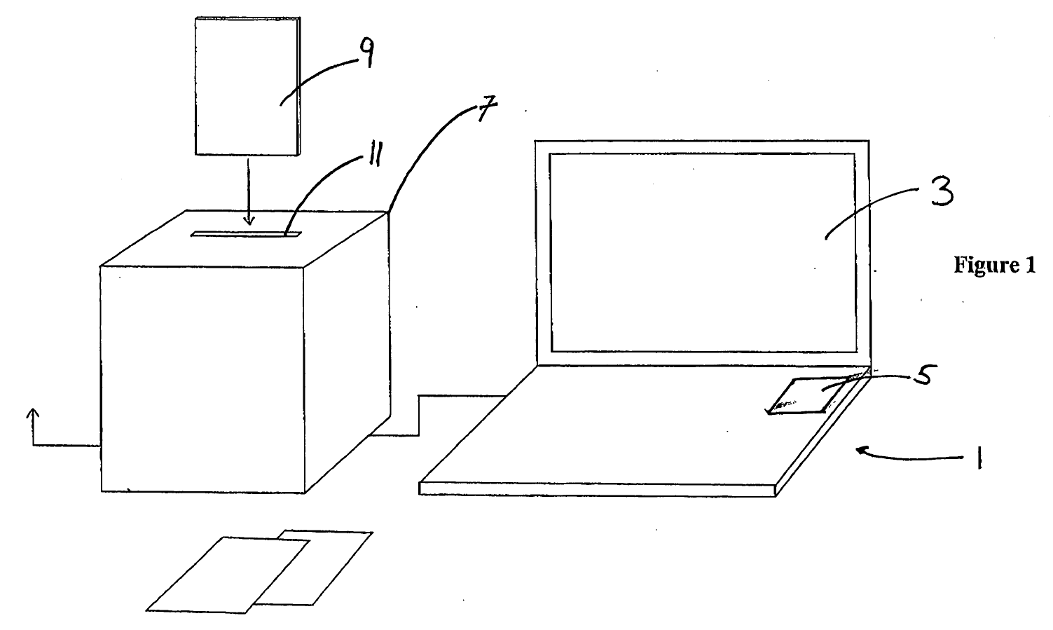

FIG. 1 is a schematic view of the hardware of the apparatus;

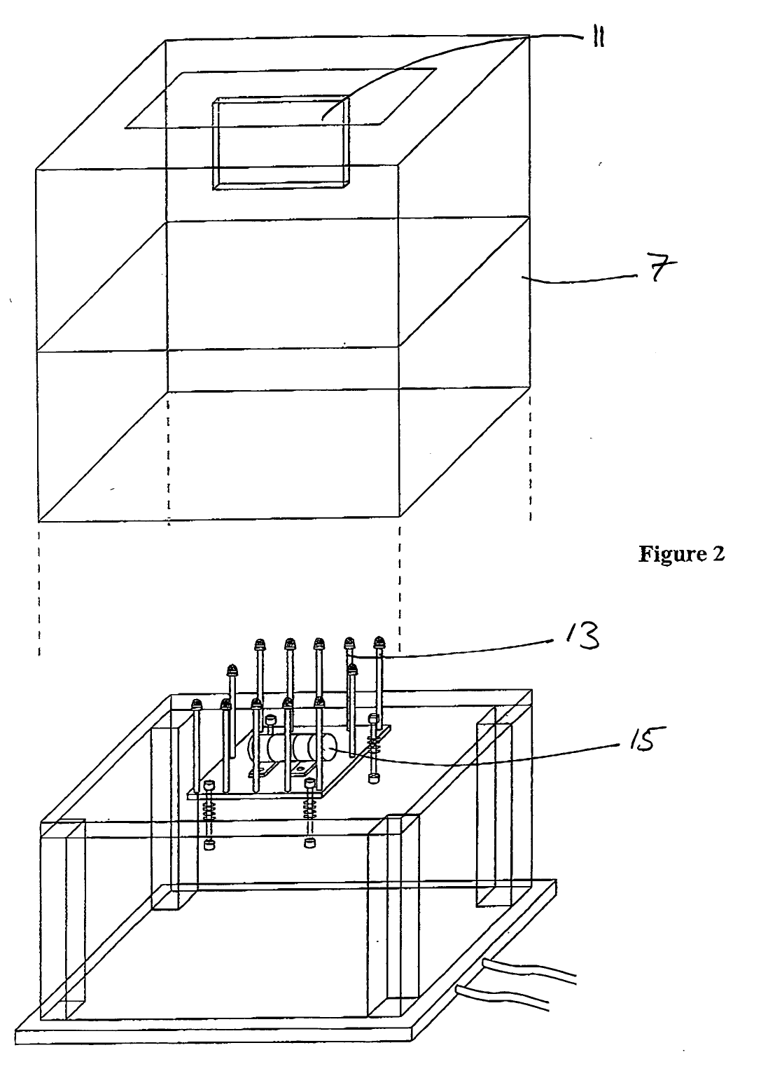

FIG. 2 is a schematic view of a RFID card reader;

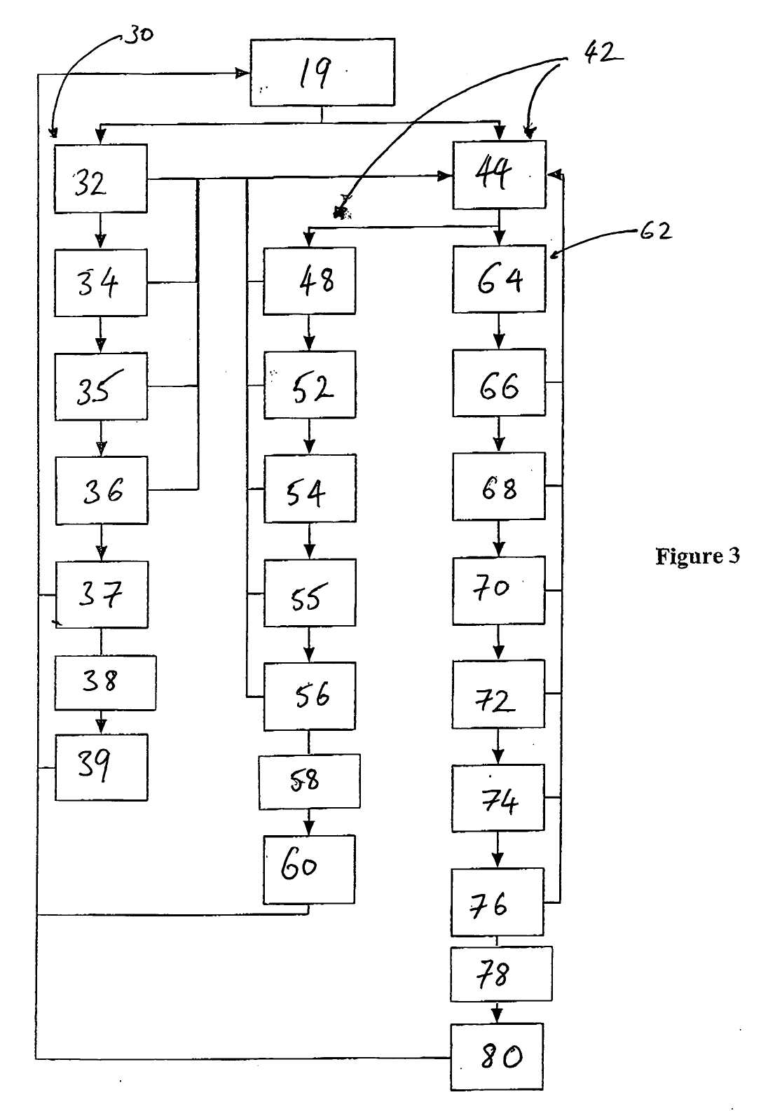

FIG. 3 is a flow diagram showing the architecture of the software of the preferred embodiment;

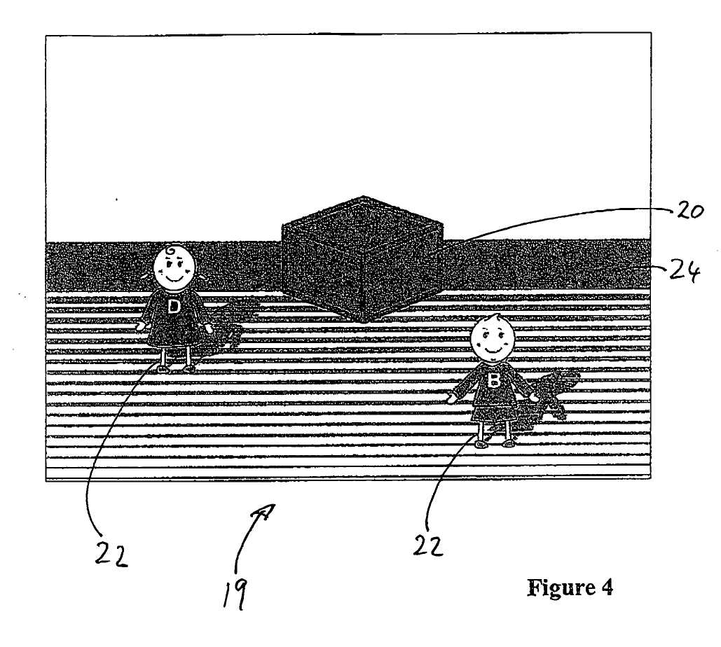

FIG. 4 is a representation of the start image on a display screen of the apparatus of FIG. 1 of the preferred embodiments during operation;

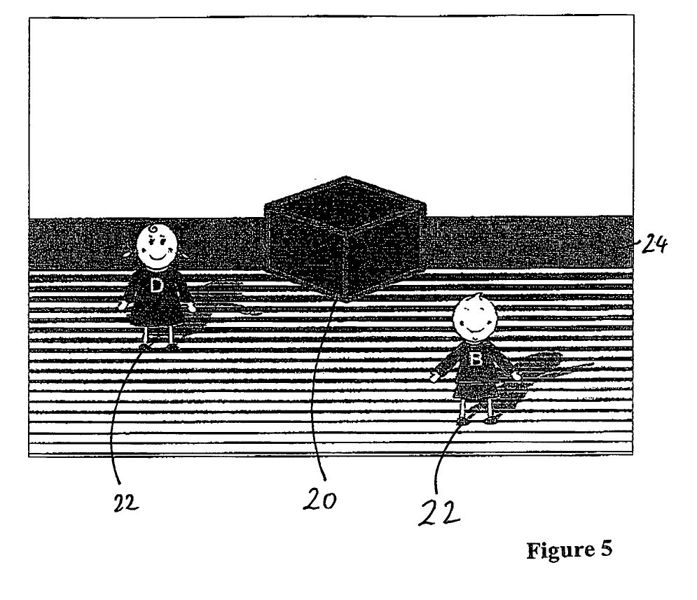

FIG. 5 is a representation of the image after the first step of the colour routine;

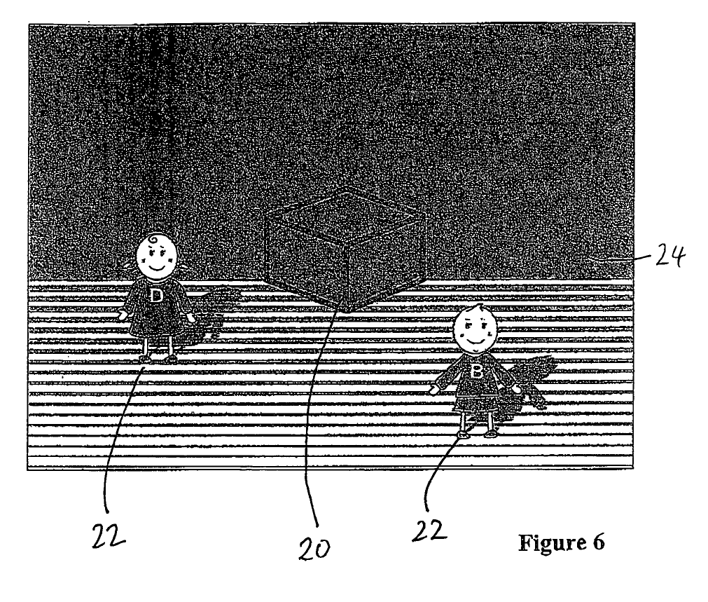

FIG. 6 is a representation of the image after the fifth step of the colour routine, after entering the same card five times;

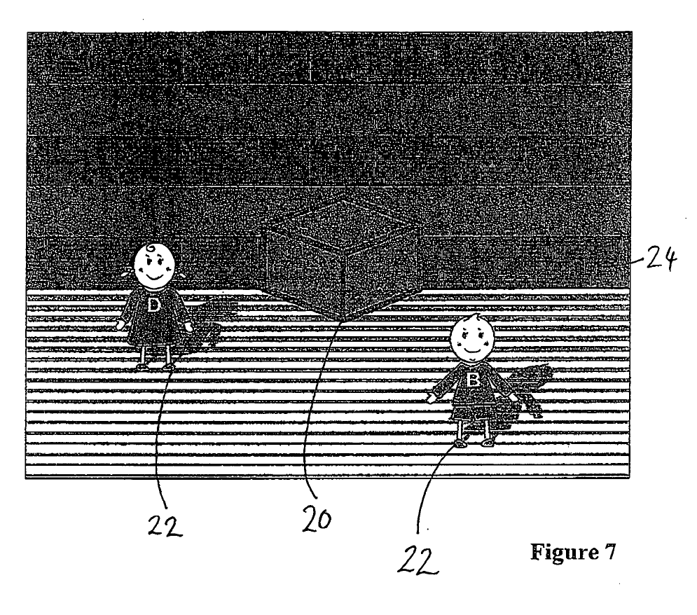

FIG. 7 is an image after the fifth step of the colour routine, after entering two different colour cards alternately;

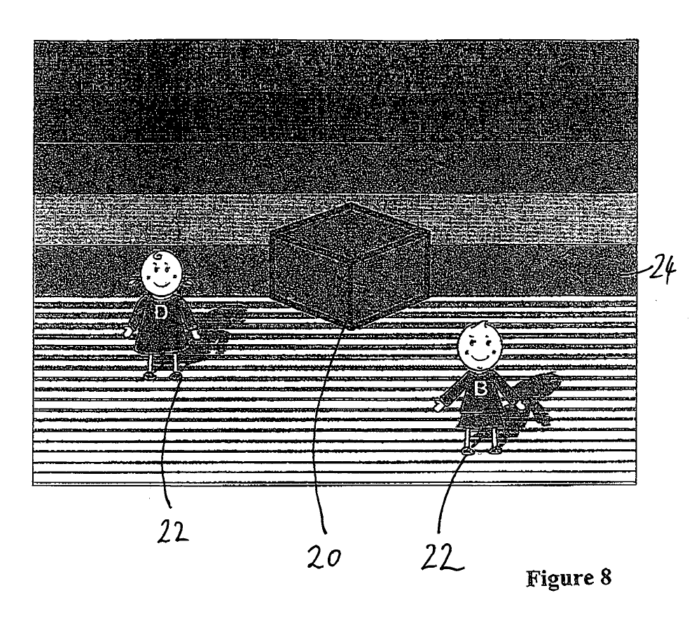

FIG. 8 is a representation of the image after the fifth step of the colour routine, after entering five different colour cards;

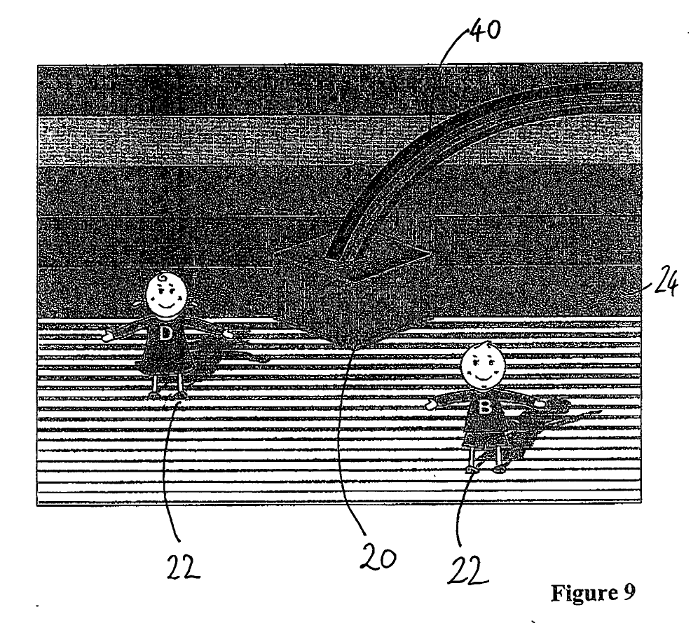

FIG. 9 is a representation of the image after the fifth step of the colour routine, showing a rainbow animation;

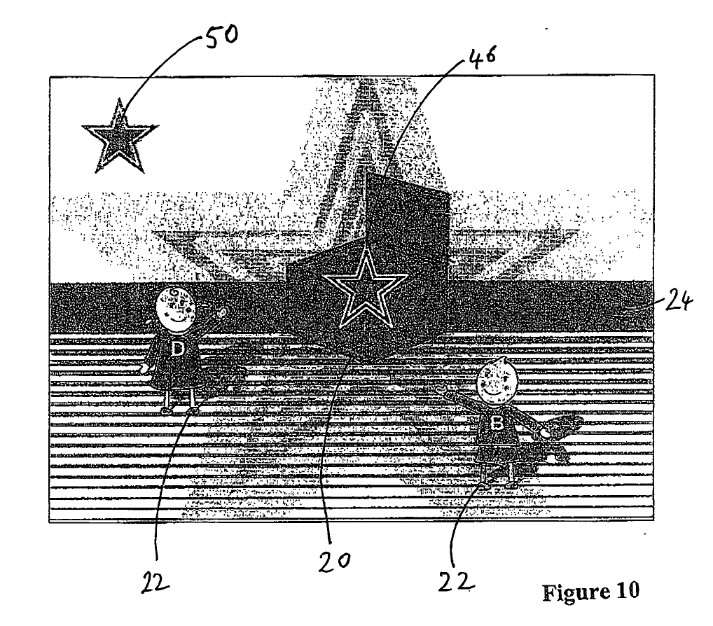

FIG. 10 is a representation of the image on the second step of the shape routine, on entering a first colour card;

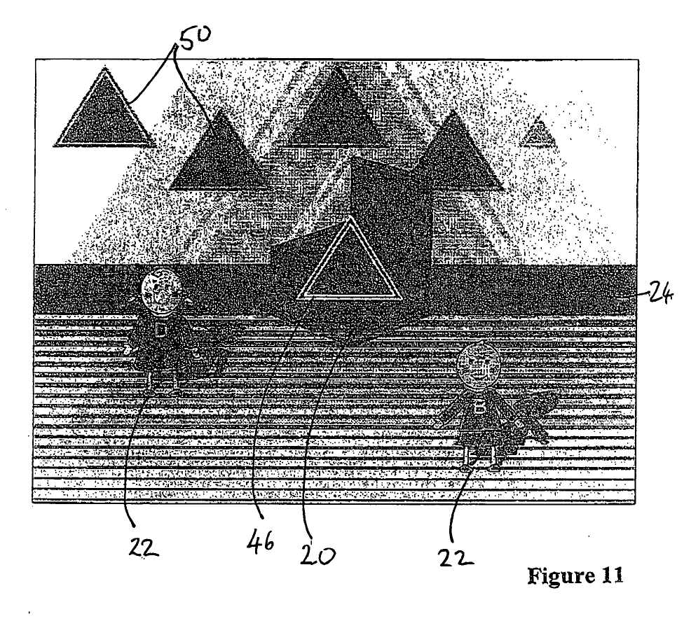

FIG. 11 is a representation of the image on the sixth step of the shape game, on entering the fifth and last colour card;

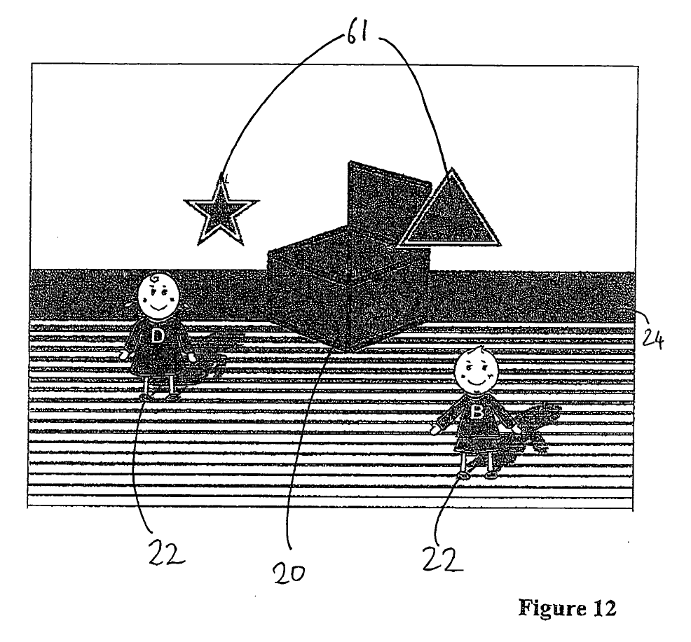

FIG. 12 is a representation of the image on the second step of the object routine, on entering the second shape card;

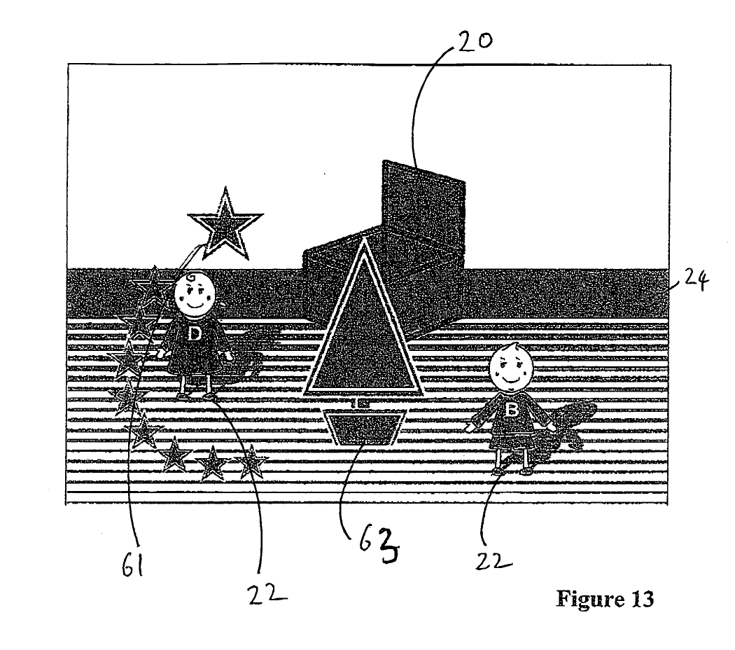

FIG. 13 is a representation of the image after the third step of the object routine, on entering the second shape card; and

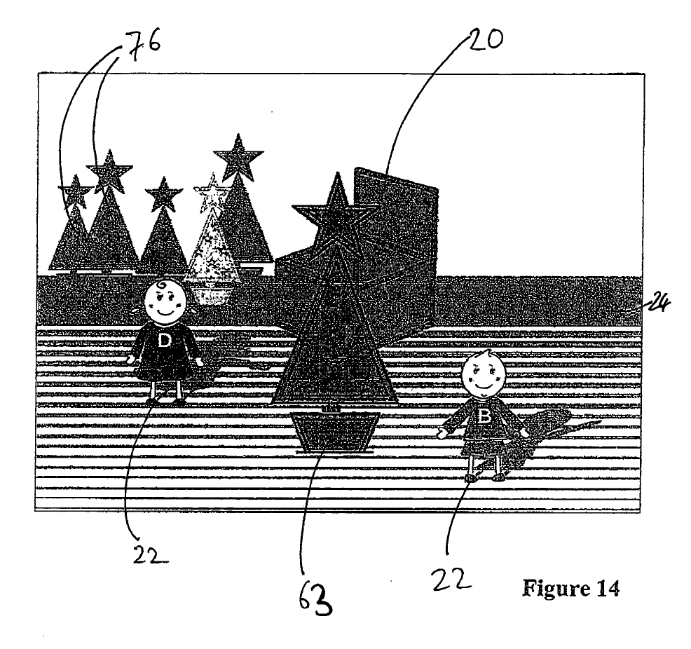

FIG. 14 is a representation of the image after the seventh step of the object routine, on entering a fifth colour card.

The hardware of the apparatus is shown in FIG. 1. It comprises a computer 1, with a display screen 3 and a loudspeaker 5. The computer is connected by a cable to an RFID box 7 for reading cards 9. The cards are substantially rigid, and substantially two-dimensional objects. The RFID box 7 has a slot 11 for accepting the cards 9. The slot 11 in the box 7 is surrounded by a perspex inlay and inside the box there is a set of red and green bipolar LEDs 13 mounted on a platform. The LEDs turn green to indicate the box 7 is ready for a card to be inserted into the slot 11. When a card 9 is slotted into the slot 11, the LEDs turn from green to red indicating that a RFID tag reader 15 within the box 7 has read the RFID card 9.

Once the RFID tag reader 15 has read the card 9, it sends a signal, comprising the data within the RFID card 9 to the computer 1. The data concerns a physical feature of the card, such as its shape or its colour. The computer 1, operating software of the apparatus, receives the signal, processes it and causes an image (which may be still or an animation) to appear on the screen 3 and a sound to be broadcast from the loudspeaker 5.

A schematic representation of the RFID box 7 showing the main components of the box is shown in FIG. 2.

The RFID box 7, and its associated software and cards 9, have been designed to support self-directed play and learning for children. This is achieved through both the use of the box and cards as a physical interface that supports children's traditional play activities with these physical artefacts, that is, putting the cards into the box, and playing with the cards. The software is written in a way that supports both linear and non-linear play. That is to say, there are multiple routes to the three different games (learning activities) that are available. For linear play, the student does not have to obtain a specified start screen, and non-linear play is achievable by the ability to move between the different games whilst one of them is operational. The open-ended nature of the software enables children to choose the type of play or learning routine they wish to follow through card placement, and also to close the path the routine follows in a way that supports their natural play patterns. Therefore, the children have a higher degree of control over their learning.

In this preferred embodiment, the software provides three modes of operation such that the children can follow three routines: a colour routine, a shape routine and an object routine. The three routines are shown in FIG. 3. The computer 1, when operating the software, causes the screen 3 to display a start image 19, as shown in FIG. 4, which is common to all three modes. The screen shows an image of a box 20 and two characters 22. The box, the characters and a history element 24, are all shown in grey. The history element serves as a reminder to the child which card they have used in that particular routine.

In this embodiment there are eleven cards 9, of which five are differently coloured cards, five are differently shaped cards, and one restart card.

When a restart card is put into the box 7, the computer 1 is arranged to cause the screen 3 to return to this start image. To begin their play, a child can choose any card. If a colour card is inserted into the slot 11, the child initiates the colour routine. If a shape card is inserted into the slot 11, the computer 1 causes the screen 3 to begin the shape routine

In each of the routines, when a card 9 is put into the slot 11, the illuminated LEDs change from green to red and the computer 1 is arranged to cause the screen 3 to show an animation and to cause the loudspeaker 5 to broadcast an English word or phrase and the corresponding French word or phrase, associated with the animation. At the end of each routine, the computer causes the screen 3 and the loudspeaker 5 to broadcast an end or a final animation. However, the end animation is only initiated if the child completes a predetermined combination of cards. The end animation comprises a rhyme in French that relates to the image. After displaying the end animation, the computer is arranged to cause the screen 3 to display a start image 19. The steps in each of the three modes is more clearly shown in FIG. 3.

The colour routine 30 is initiated by a colour card 9 being put into the RFID box 7. This is the first step 32 of the colour routine 30. On entry of the first card, parts of the screen 3 is programmed to be in the colour of the colour of the card entered into the RFID box 7. The parts of the screen 3 that are thus coloured in include a box 20, two characters 22 and a history element 24, as shown in FIG. 5. In this Figure, a blue colour card has been entered in the first step of the routine. In this case, the English and French words for blue are broadcast sequentially. When the colour card 9 is removed from the RFID box 7, the RFID box sends a signal to the computer 1. On receipt of this signal, the computer 1 is arranged to cause the screen 3 to show all parts of the screen that have been coloured in, in blue, to be coloured in grey, apart from the history element 24.

If a second colour card is entered into the RFID box 7, the REID box 7 sends a signal to the computer 1, whereby the computer is arranged to colour in the characters 22, the box 20 and the history element 24 in the colour of the new colour card. The history element shows the previous colour card, is shown as a colour band above the history element 24. The history element 24 showing the colour card presently in, or last entered into, the RFID box 7. This is the second step 34 of the colour routine 30. FIG. 7 shows a plurality of history elements 24.

In this embodiment, up to five colour cards can be entered. There are, therefore, three further steps 35, 36 and 37 to the colour routine 30. After the entry of the fifth colour card, the computer is arranged to cause the display screen 3 to revert to the start image 19. Therefore, up to five history elements can be shown on the screen 3.

FIG. 6 shows the image shown on the screen 3 for the colour routine 30 after the same colour card has been entered five times.

Note that on removal of a colour card, all features shown in the image on the screen 3, except the history elements 24, revert to grey, as can be seen in FIG. 6.

FIG. 7 shows an image shown on the screen 3 for a routine in which two colour cards have been entered into the RFID box 7 alternately. Therefore, a child can use the routine to build up different striped patterns as an image on the screen 3, before the child is taken back to the start image 19.

However, in this colour routine 30 when each of the five colour cards are entered, in any sequence, the routine does not return immediately to the start image 19. After receipt of the fifth different colour card, the computer is arranged to transmit to the screen a further output signal which causes the screen to show a rainbow animation and the loudspeaker to broadcast a rainbow rhyme, see steps 38 and 39 in the flow chart in FIG. 3. FIG. 8 shows an image where all five colour cards have been used and FIG. 9 shows a frame from the rainbow animation. The rainbow animation shows a rainbow 40 coming out of the box 20 and the two characters 22 participating in the animation. After the end of the rainbow animation, the computer 1 is arranged to cause the screen 3 to return to the start image 19.

If at any point during this routine the restart card is entered into the RFID box 7, the computer 1 is arranged to cause the screen 3 to show the start image 19. If a shape card is entered, the computer 1 is arranged to cause the screen 3 to show the beginning of the shape routine 42, as shown in FIG. 10.

In this first step 44 of the shape routine 42, the characters 22, the box 20 and the history element 24 are all shown in grey. A shape 46, in this case a star, is shown to come out of the box. As the shape 46 comes out of the box 20 in the image, the loudspeaker is caused by the computer to broadcast the English and the French words for the shape displayed, 46. The shape routine 42 can be caused to begin also from the start image 19 by entering a shape card as the first card into the RFID box 7. If the shape card 9 is removed from the RFID box 7, the shape remains on the screen 3. At this point the child can choose to enter a colour card, to colour the shape shown on the screen 3. This is the second step 48 of the shape routine 42. On receipt of the signal from the RFID box 7, indicative of entry of the colour card into the RFID box 7, the computer 1 is arranged to cause the screen 3 to show a coloured shape to come out of the box 20, and the loudspeaker 5 to broadcast the French and English words for that coloured shape.

If a subsequent colour card is entered into the slot 11, then on receipt of the signal from the RFID box 7, the computer 1 is arranged to cause the screen 3 to show a second coloured shape to come out of the box 20 and the loudspeaker 5 to broadcast the French and English words for that coloured shape. The screen 3 retains the image of the first coloured shape. This is the history element 50 of the shape routine 42.

As shown in FIG. 11 up to five colour cards in total can be entered after the shape card. This image displayed on the screen shows up to five history elements 50. That is, there are a further four cards that can be entered in four further steps 52, 54, 55 and 56. If each of the colour cards are used in an uninterrupted sequence, the computer 1 is arranged to cause the screen 3 and the loudspeaker 5 to broadcast an animation and soundtrack in response to this predetermined combination. To do this, the computer is arranged to check if the cards entered correspond to a predetermined combination 58, and if it does, to initiate the animation and the soundtrack 60. After this animation and soundtrack, the screen is returned to the start image 19. The soundtrack comprises a simple rhyme in French and English relating to the animation.

If at any stage during the shape routine 42, after a colour card has been entered, a further shape card is entered into the RFID box 7, a new shape routine is commenced.

The computer is arranged to cause the screen 3 to display an image corresponding the first step 44 of the shape routine. If the shape card is entered immediately after the first step 44 of the shape routine 42, the object routine 62 is begun.

The object routine 62 begins, if two shape cards are entered sequentially into the RFD) box 7. The computer 1 is arranged to cause the screen 3 to show both shapes 61 in an image on the screen 3, as shown in FIG. 12. This is the first step 64 of the object routine 62. The shapes are combined by morphing them into a predetermined object 64, for example, in FIG. 13, the star and the triangle are shown to morph into a Christmas tree 63. This is the second step 66 of the object routine. The French and English words for these shapes and the object are caused by the computer 1 to be broadcast from the loudspeaker 5. If a further shape card is entered, the computer 1 is arranged to cause a new shape routine to commence. If, however, a colour card is entered into the slot 11, the computer 1, on receipt of the signal from the RFD box 7, is caused to colour in the object 63 appropriately. This is the third step 68 of the object routine 62.

Up to five colour cards may be entered into the RFID box 7. So the computer 1 causes the screen 3 to show an image of five coloured objects, as in FIG. 14. Thus there are four further steps, 70, 72, 74 and 76, to the object routine 62.

If all five colour cards are used in one operation of the object routine 62, after entry of the fifth colour card 9, the computer 1 is arranged to cause the screen 3 to show an animation and cause the loudspeaker 5 to broadcast an associated soundtrack. The soundtrack comprises a rhyme in English and in French. The computer 1 is arranged to check if the entered cards correspond to a predetermined combination in a seventh step 78, i.e. if the combination of colour cards has been completed. If it has, in an eighth step 80, the animation and soundtrack are initiated to be broadcast by the computer 1. The five coloured objects shown in FIG. 14 act as history elements 76. After this broadcast, the computer is arranged to cause the screen to display start image 19.

As there are five different shape cards, there are ten different ways of choosing two of the cards, to provide an object. Thus, there can be up to ten different objects for these cards. This increases the number of operations a user can carry out on the computer 1 using a simple operator interface. Therefore, the number of words and phrases that can be taught by using a computer running language teaching software can be increased.

If two shape cards are entered sequentially and the cards are the same shape, on entering the second shape card, the display is unchanged and the associated English/French audio file is repeated.

In a modification of this embodiment, the words of only one language are broadcast, e.g. French. Alternatively any language may be used.

In another embodiment, this system can be used to teach subjects other than languages, including, for example, history, science, including astrology and biology, and geography. The images appearing on the screen, the sounds broadcast, the soundtracks, the objects and other features of the preferred embodiment may be thus selected to suit routines designed for teaching those other subjects, based on the associated data stored in the computer and accessed via, for example, an RFID tag of the item. Thus in one example, the items (e.g. cards) may relate to various parts of the body, and activation of the items (e.g. reading an RFID tag) can be arranged to display an image of that part in its correct location in the body on a screen.

In another embodiment, the only output is sound. In an alternative embodiment, the only output is a visual display.

In a further modification, the order in which the cards are entered into the RFID box is significant. In this modified embodiment the computer is caused to respond to a predetermined combination of signals from the RFID box that correspond to a predetermined sequence of cards.

In a further embodiment of the routines described herein, if, at the beginning of a routine, a shape card and a colour card are entered in the RFID box, the computer is arranged to cause the display screen, and the loudspeaker to broadcast the English and French words (for example) for, an additional animated object before reverting to the shape routine. For example, if a triangle card and then a red card are entered into the RFID box, the screen is caused to show an image of a volcano, with the loudspeaker caused to broadcast the English and French words for “volcano”.

Furthermore, the apparatus and routines can be modified to respond to patterned cards.

The colour routine can be modified to accept shape cards. In the embodiment described above, on entering a shape card in a colour routine, the image shown on the screen would correspond to the first step of the shape routine. However, in this modification, the image shown on the display screen would have coloured shapes added to the image of the colour game, enabling the student to create coloured patterns. This can be further facilitated by the provision of further shape and colour cards.

In another modification another pre-programmed sequence can be activated. If whilst the shape routine is in operation each of the five coloured cards is used one after the other, an animated sequence is arranged to be operated that is similar to the one activated by the sequential placement of each of the five different colour cards in the operation of the colour routine.

A teacher control interface may be provided that would enable the teacher to set preferences, for example to turn the English audio on or off or to choose two languages from a database, for example, of English and French, English and German, or French and German. The settable preferences would also enable a user to record a particular child's choices and progress through the routine to understand the child's learning preferences, and to assess the child's learning and development.

In a further addition, there could be a repeat word RFID card. On entering the card into the RFID box, by a supervisor, be it a teacher or a parent, would enable the child to hear again the audio track last broadcast from the loudspeaker.

The cards may be designed to be used as flash cards for group play or play in pairs or play by individuals, with or without a teacher.

The apparatus may comprise a standard computer, for example a PC, which may be a laptop. The software and hardware is adaptable for use with interactive TV, mobile devices and game console technology, and other operating platforms.

The embodiment herein described are each only intended to be an example of an embodiment of the invention. The description is intended to incorporate all variations, modifications, adaptations and permutations of the aforementioned modifications and embodiments, that have the same advantages as the embodiment herein described.

1. A computerized teaching apparatus, the apparatus comprising:
a plurality of items each comprising a computer-readable medium arranged to store data that corresponds to a physical attribute of the item;
a reader arranged to generate input signals, each input signal representing the data stored on the computer-readable medium of one item; and
a computer programmed to receive the plurality of input signals sequentially and arranged to generate, in response to a detection of a stored predetermined combination of input signals an output signal representative of that combination.

2. Apparatus as claimed in claim 1, wherein the computer-readable medium comprises an RFID tag.

3. Apparatus as claimed in claim 1, wherein the physical attribute of any particular item is one of a number of categories, comprising the shape of, the colour of, or the patterning on, that item.

4. Apparatus as claimed in claim 3, wherein said predetermined combination corresponds to physical attributes in the same category.

5. Apparatus as claimed in claim 4, wherein said predetermined combination includes two items having different shapes, the computer being programmed to generate an output signal corresponding to an object in response to detection of that combination.

6. Apparatus as claimed in claim 1, wherein said predetermined combination corresponds to physical attributes in different categories.

7. Apparatus as claimed in claim 1, comprising a device to display visually the output signal.

8. Apparatus as claimed in claim 7, wherein the computer is programmed to transmit the input signal sequentially to the device to visually display an image, each image being related to the physical attribute of the item represented by the input signal.

9. Apparatus as claimed in claim 1, comprising a device to broadcast audibly the output signal.

10. Apparatus as claimed in claim 9, wherein the computer is programmed to transmit the input signals sequentially to the device to broadcast audibly a series of sounds, each sound being related to the physical attribute of the item represented by the input signal.

11. Apparatus as claimed in claim 1, wherein the computer is programmed to generate a termination signal, the termination signal being generated on detection by the computer of not more than ten of said input signals that do not correspond to a predetermined combination.

12. Apparatus as claimed in claim 11, wherein the number of input signals detected by the computer before generation of the termination signal is not more than five.

13. Apparatus as claimed in claim 1, wherein the predetermined combination is a predetermined sequence.

14. Apparatus as claimed in claim 1, wherein the items are substantially rigid, two-dimensional cards and the reader is a card reader.

15. A computerized teaching method for use in a computerized teaching apparatus, wherein each one of a plurality of items comprises a computer readable medium arranged to store data that corresponds to a physical attribute of the item, the method comprising the steps of:
(1) generating input signals, each input signal comprising the said data read from the computer-readable medium of one of the items;
(2) sequentially receiving the input signals; and
(3) in response to the detection of a predetermined combination of input signals, generating an output signal representative of that combination.

16. A method as claimed in claim 15, wherein the output signal comprises a visual signal that is displayed on a screen.

17. A method as claimed in claim 15, wherein the output signal comprises an audio signal that is broadcast.

18. A method as claimed in claim 15, wherein the method comprises the step of sequentially transmitting each input signal to a device to broadcast a representation of the physical attribute of the item represented by each input signal.

19. A method as claimed in claim 15, wherein the method comprises the step of generating a termination signal on detection of not more that ten of said input signals that do not correspond to the predetermined combination.

20. A method as claimed in claim 19, wherein the number of input signals detected before generation of the termination signal is not more that five.

21. A method as claimed in claim 15, wherein the predetermined combination is a predetermined sequence of the input signals.

22. A method as claimed in claim 15, wherein the physical attribute of any particular item is one of a number of categories comprising the shape of, the colour of, or the patterning on, that item, and said predetermined combination corresponds to physical attributes in the same category.

23. A method as claimed in claim 22, wherein said predetermined combination includes two items having different shapes, the output signal corresponding to an object being generated in response to the detection of that combination.

24. A method as claimed in claim 15, wherein the physical attribute of any particular item is one of a number of categories comprising the shape of, the colour of, or the patterning on, that item and said predetermined combination corresponds to physical attributes in different categories.

25. A computerized teaching method for a computerized teaching apparatus, wherein each one of a plurality of items comprises a computer-readable medium arranged to store data that corresponds to a physical attribute of the item, the method comprising the steps of:
(1) generating input signals, each input signal comprising the said data read from the computer-readable medium of one of the items;
(2) sequentially receiving the input signals;
(3) in response to the detection of a predetermined combination of the input signals, generating an output signal representative of that combination;
(4) transmitting the output signal simultaneously to a visual display for visually displaying a predetermined image and to an audio device for broadcasting a predetermined sound in a first language and in a second language, the image and sound being associated with the predetermined combination.

26. (canceled)

27. (canceled)
